(19) United States
(12) Patent Application Publication
(10) Pub. No.: US 2025/0018714 A1
(43) Pub. Date: Jan. 16, 2025

(54) MANUFACTURING METHOD OF LIQUID DISCHARGE HEAD

(71) Applicant: CANON KABUSHIKI KAISHA, Tokyo (JP)

(72) Inventors: KEIJI MATSUMOTO, Kanagawa (JP); MASATAKA NAGAI, Kanagawa (JP)

(21) Appl. No.: 18/753,073

(22) Filed: Jun. 25, 2024

(30) Foreign Application Priority Data
Jul. 11, 2023 (JP) 2023-114065

(51) Int. Cl. B41J 2/16

(52) U.S. Cl. CPC B41J 2/1631; B41J 2/1628; B41J 2/1642

(57) ABSTRACT

A manufacturing method of a liquid discharge head for manufacturing a liquid discharge head by transferring a resist to a board having a liquid supply port of the liquid discharge head includes a first step of transferring the first resist to the board by relatively moving a transfer member to a first direction in a state where the transfer member is pressed from a side opposite to a side opposed to the board with respect to the first resist. The method includes a second step of transferring the second resist onto the first resist by relatively moving the transfer member to a second direction, which is different from the first direction, in a state where the transfer member is pressed from a side opposite to a side opposed to the first resist with respect to the second resist.

### BACKGROUND OF THE INVENTION

### Field of the Invention

An art of the present disclosure relates to a manufacturing method of a liquid discharge head which performs a recording operation by discharging liquid.

### Description of the Related Art

Conventionally, such a liquid discharge head is known that a nozzle including a liquid supply port for supplying liquid, a discharge port for discharging the liquid onto a board having an energy generating element, and a flow passage for supplying the liquid to a discharge port portion is formed. In general, in order to realize high-quality prints, a thickness of the nozzle of the liquid discharge head and an opening dimension of the discharge port are required to be formed with accuracy.

Japanese Patent Application Publication No. 2020-49752 discloses a manufacturing method of a liquid discharge head in which a nozzle which discharges liquid by dry-film resist is formed on a board including a liquid supply port. In this method, after a flow-passage forming member is formed by laminating a first dry film so as to cover a base step of the board on the board having the liquid supply port, a discharge-port forming member is formed by laminating a second dry film. Then, the discharge port for discharging the liquid and the flow passage are formed by a photolithographic art.

However, when the dry films, which will be the flow-passage forming member or the discharge-port forming member, are to be laminated, not a small variation in a thickness occurs due to pressure distribution or temperature distribution specific to an apparatus. Particularly, when the same apparatus is used in plural times, as the result of overlap of similar variation in the thickness, the thickness of the laminated dry films cannot become uniform easily in the board surface. A plurality of chips to be mounted on the liquid discharge head are formed in the board surface, but if a length of one chip is prolonged for improvement of print performances, the thickness of the nozzles disposed in the chip cannot easily become uniform, and the opening dimension of the discharge port formed by a photolithographic art cannot become uniform easily, either. Therefore, there is a concern that it would be difficult to manufacture a high-quality liquid discharge head.

### SUMMARY OF THE INVENTION

An art of this disclosure was made in view of the above and has an object to make the thickness of the dry film used for the liquid discharge head uniform with accuracy.

According to some embodiments, a manufacturing method of a liquid discharge head for manufacturing a liquid discharge head by transferring a resist to a board having a liquid supply port of the liquid discharge head includes in order to transfer a first resist to the board, a first step of transferring the first resist to the board by relatively moving a transfer member to a first direction in a state where the transfer member is pressed from a side opposite to a side opposed to the board with respect to the first resist, and in order to transfer a second resist onto the first resist having been transferred to the board, a second step of transferring the second resist onto the first resist by relatively moving the transfer member to a second direction, which is different from the first direction, in a state where the transfer member is pressed from a side opposite to a side opposed to the first resist with respect to the second resist.

Further features of the present invention will become apparent from the following description of exemplary embodiments with reference to the attached drawings.

### BRIEF DESCRIPTION OF THE DRAWINGS

FIG. 1 is a perspective schematic view illustrating an example of a liquid discharge head according to an Embodiment.

FIG. 2 is a sectional schematic view of the liquid discharge head by an A-A′ line in FIG. 1.

FIGS. 3A to 3F are schematic diagrams illustrating a process example of a manufacturing method of the liquid discharge head according to Embodiment.

FIG. 4 is a block diagram illustrating a partial configuration of a transfer device according to Embodiment.

FIG. 5 is a schematic diagram illustrating a roller unit of the transfer device according to Embodiment.

FIGS. 6A and 6B are schematic diagrams illustrating an example of transfer by the roller unit according to Embodiment.

FIGS. 7A to 7E are upper-surface schematic diagrams illustrating an example of the transfer of a resist according to Embodiment.

FIGS. 8A to 8D are upper-surface schematic diagrams illustrating another example of the transfer of a resist according to Embodiment.

FIGS. 9A and 9B are upper-surface schematic diagrams illustrating an example of the transfer of a resist according to a conventional art.

FIGS. 10A and 10B are sectional schematic diagrams illustrating a resist in a conventional art.

FIGS. 11A and 11B are sectional schematic views illustrating a resist in an example of the transfer in Embodiment.

### DESCRIPTION OF THE EMBODIMENTS

Hereinafter, preferred embodiments of an art of this disclosure will be explained in detail on the basis of attached drawings. Note that, in each drawing, the same reference numerals are given to the same members, and duplicated explanation will be omitted. Hereinafter, each of Embodiments will be explained in more detail. Moreover, numerical values shown in each of Examples below are examples, and the art of this disclosure is not limited to them. Furthermore, the art of this disclosure is not limited to each of Examples but includes those further combining them and those applied to other technical fields.

### First Embodiment

Hereinafter, a manufacturing method of a liquid discharge head according to First Embodiment of the art of this disclosure will be explained. As will be explained below, the liquid discharge head manufactured by using a dry film is mounted on an inkjet printer (not shown), for example. There are various types of inkjet printers, but in general, a carriage (not shown) movable in a scanning direction is provided in a printer, and the carriage has a liquid discharge head for discharging ink onto a print medium. The ink is supplied from an ink tank via a liquid flow passage to the liquid discharge head and is discharged to the print medium from a discharge port provided in the liquid discharge head. And by repeating scanning by the carriage and the discharge of the ink from the liquid discharge head, a desired print pattern is printed on the print medium.

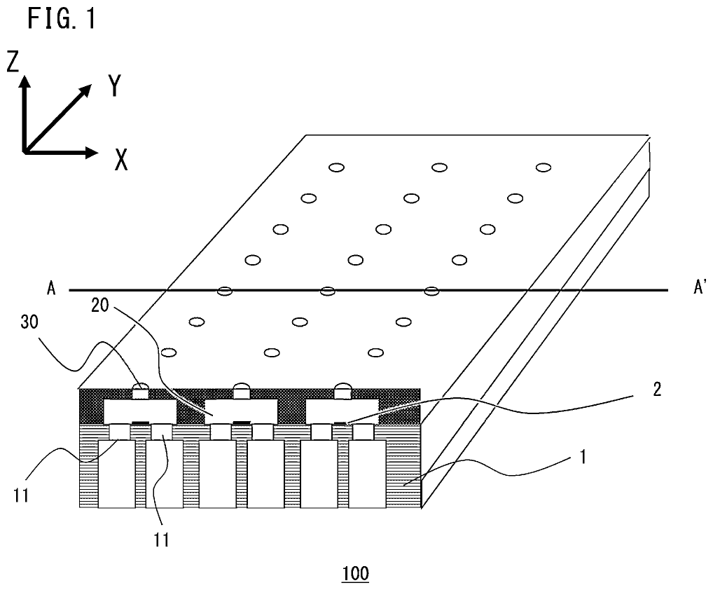

FIG. 1 is a perspective view schematically showing an example of a liquid discharge head of this Embodiment. As shown in FIG. 1, a coordinate system made of an X-axis, a Y-axis, a Z-axis orthogonal to one another is set for the liquid discharge head 100. The liquid discharge head 100 has a board 1 in which energy generating elements 2 are disposed by being aligned at a predetermined pitch in the Y-axis direction. On the board 1, a liquid flow-passage 20, and a liquid discharge port 30 located above (positive Z-axis direction) of the energy generating element 2 are formed. Moreover, on the board 1, a liquid supply port 11 is formed on both sides of the energy generating element 2 in the X-axis direction. Nozzle rows constituted by the liquid supply port 11, the liquid flow-passage 20, the liquid discharge port 30, the energy generating element 2 are disposed in plural rows in the X-axis direction. When a pressure is applied to the liquid flown-in through the liquid supply port 11 and flowing in the liquid flow-passage 20 by means of energy generated by the energy generating element 2, the liquid is discharged from the liquid discharge port 30 as droplets. When this droplet adheres to the recording medium, the recording can be performed. The energy generated by the energy generating element 2 may be so-called thermal type energy or may be so-called piezo type energy. Note that, in the following explanation, the energy generating element 2 is assumed to be an energy generating element used for the thermal type.

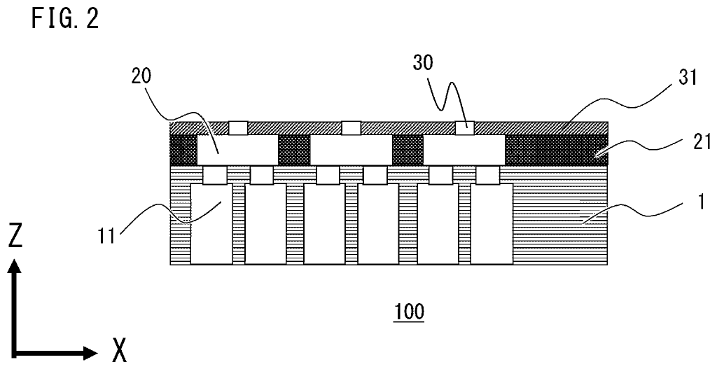

Subsequently, by using FIG. 2, the liquid discharge head 100 will be explained. FIG. 2 is a sectional schematic diagram of the liquid discharge head 100 by an A-A′ line in FIG. 1. In the liquid discharge head 100, a plurality of the energy generating elements 2 (not shown) are disposed on the board 1, and an insulating protective film (not shown) is formed from above that. Moreover, on the board 1, the liquid supply port 11 for supplying the liquid to the liquid flow-passage 20 is formed. A flow-passage wall defining the liquid flow-passage 20 is formed by a flow-passage forming member 21, and the liquid discharge port 30 is formed by a discharge-port forming member 31. Here, the insulating protective film is patterned by photolithography, dry etching or the like in compliance with an opening of the liquid supply port 11. The liquid supply port 11 communicates with the liquid flow-passage 20 and the liquid discharge port 30.

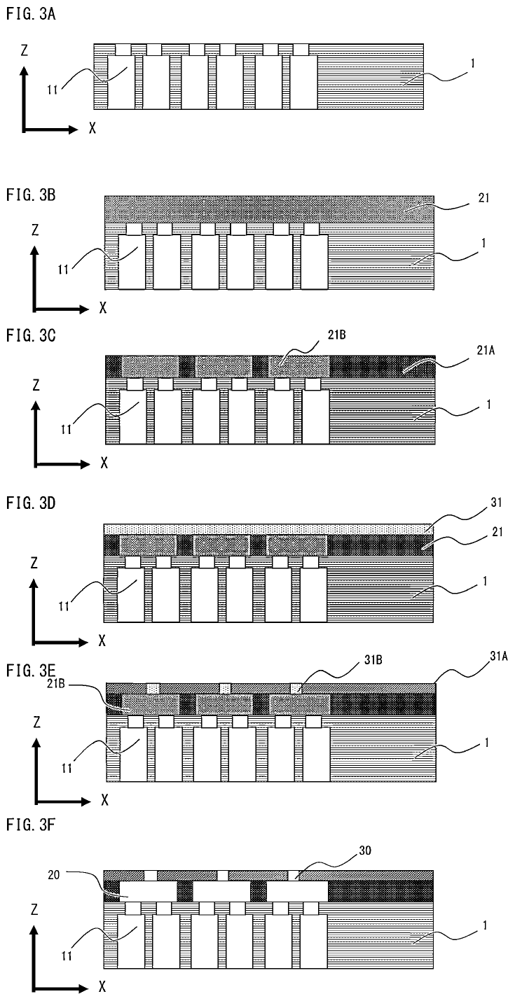

Subsequently, by using FIGS. 3A to 3F, the manufacturing method of the liquid discharge head 100 will be explained. In FIGS. 3A to 3F, sectional schematic diagrams of the liquid discharge head 100 by the A-A′ line in FIG. 1 are shown. As shown in FIG. 3A, a plurality of the energy generating elements 2 (not shown) are disposed on the board 1, and the insulating protective film (not shown) is formed from above that. A material of the board 1 is not particularly limited as long as it is a material usable as a semiconductor element board such as silicon. Moreover, the material of the energy generating element 2 is not particularly limited as long as it is a resistor body such as TaSiN and can apply a pressure to the liquid when the energy generating element 2 receives an electric signal and heats the liquid. Moreover, the material of the insulating protective film is not particularly limited as long as it is an insulating film such as SiN, SiC, SiO or the like and can protect an electric wiring of the liquid discharge head 100 from the ink and other liquids. Moreover, the liquid supply port 11 is formed by penetrating the board 1 by dry etching or the like, but a machining method of the liquid supply port 11 is not particularly limited as long as the liquid supply port 11 can be formed so as to penetrate the board 1.

Subsequently, as shown in FIG. 3B, as a first step, the flow-passage forming member 21 fixed to a base film (not shown) is transferred to the board 1. A dry-film resist is used for the flow-passage forming member 21, and the material of the base film is not particularly limited as long as it is a material stable with respect to a heat history of the flow-passage forming member 21 such as polyethylene terephthalate, polyimide and the like. Moreover, the material of the flow-passage forming member 21 is preferably a negative photosensitive resin. A film thickness of the flow-passage forming member 21 having been transferred to the board 1 becomes thinner as compared with the film thickness of the flow-passage forming member 21 before the transfer to the board 1, since the heating and the pressurization are performed at the transfer.

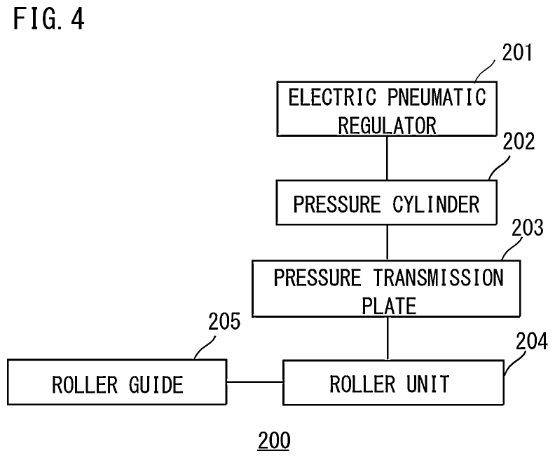

Here, a transfer device 200 which performs transfer of the flow-passage forming member 21 to the board 1 will be explained by reference to the drawings. FIG. 4 is a block diagram showing a configuration related to a roller unit in the configuration of the transfer device 200. As shown in the drawing, the transfer device 200 has an electric pneumatic regulator 201, a pressure cylinder 202, a pressure transmission plate 203, a roller unit 204, a roller guide 205.

In the transfer device 200, air is pressure-controlled by the electric pneumatic regulator 201 and transmitted to the pressure cylinder 202. The pressure cylinder 202 presses the pressure transmission plate 203 by using the air transmitted from the electric pneumatic regulator 201. The roller unit 204, which is a transfer member, is connected to the pressure transmission plate 203. Moreover, the roller unit 204 is engaged with the roller guide 205. And the roller unit 204 performs scanning along an extending direction of the roller guide 205 on the basis of control by a roller control portion (not shown).

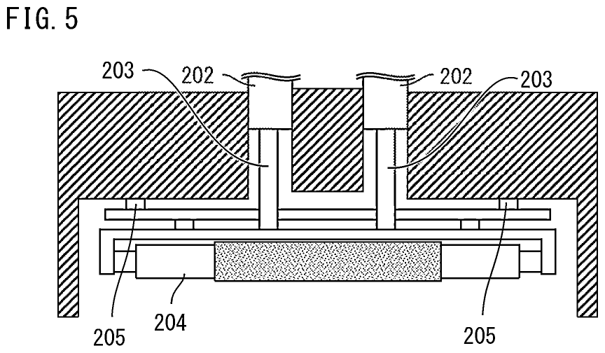

FIG. 5 is a diagram schematically illustrating drive of the roller unit 204 of the transfer device 200. When the dry film resist is to be transferred to the board 1 by the transfer device 200, first, the roller unit 204 is heated to a set temperature. Then, by means of the pressure control by the electric pneumatic regulator 201, the pressure transmission plate 203 is pressed by the pressure cylinder 202, and the roller unit 204 is lowered. At this time, the roller unit 204 lowers with the pressure transmission plate 203 in a state of being engaged with the roller guide 205. And the roller unit 204 moves in the scanning direction in a state of pressing the dry film resist onto the board 1.

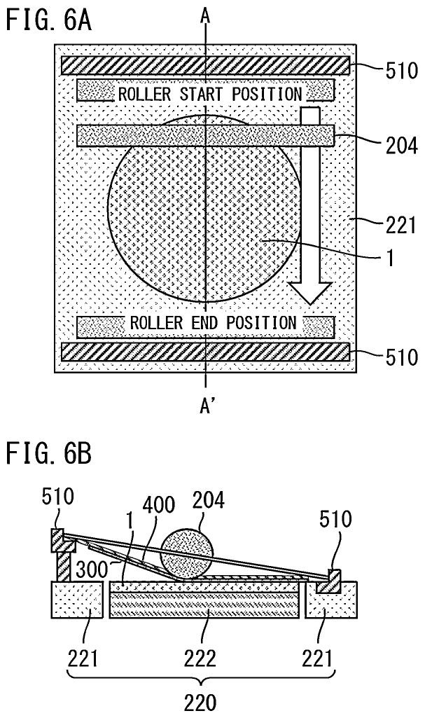

FIG. 6A is a top view of a stage 220 schematically illustrating a state where the dry-film resist is transferred to the board 1 by the roller unit 204. Moreover, FIG. 6B is a sectional view by the A-A′ line in FIG. 6A. As shown in FIG. 6A, first, the board 1 is placed on the stage 220. The stage 220 has an outer-peripheral stage 221 surrounding the board 1 and an inner-peripheral stage 222 on which the board 1 is placed. The outer-peripheral stage 221 has a frame-holding mechanism 510 as shown in FIG. 6B. Moreover, in this Embodiment, as an example, the dry-film resist is given by a sheet-type dry film. Here, the sheet-type dry film is obtained by fixing a base film onto the frame framed by SUS (stainless steel) and by drying after resist is formed on the base film so as to make it into a dry film.

In the transfer device 200, due to the fact that the shaft and the roller of the roller unit 204 are not perfectly horizontal, a variation in a pressure specific to the transfer device is generated. It is not realistic that horizontal leveling of the shaft or the roller of the roller unit 204 is perfectly performed, but since rubber is used on a surface of the roller, even if the roller-shaft direction is not perfectly horizontal, the surface of the board 1 fixed to the stage 220 is followed by deformation of the rubber. Moreover, since the board 1 has a round shape, when a linear pressure is applied by the roller unit 204, a contact area between the roller and the board changes during the scanning, and an actual pressure to the board 1 is different even if pressurization by the roller unit 204 is the same. Thus, in the stage 220, the change of the contact area of the base pressurized in a scanning area of the roller is prevented by providing the outer-peripheral stage 221 on an outer side of the inner-peripheral stage 222 supporting the board 1 in order to suppress the variation in the contact area.

The roller unit 204 moves from a roller start position toward a roller end position by sliding (pulse-motor driving) one side of the shaft, which is a rigid body formed in a lattice state, in the horizontal direction. The outer-peripheral stage 221 can obtain such an effect that the linear pressure applied by the roller unit 204 to the board 1 is made constant by receiving the pressure of the roller unit 204 together with the board 1 at the scanning of the roller unit 204. Moreover, as shown in FIG. 6B, a height of the inner-peripheral stage 222 is set such that, when the board 1 is placed on the inner-peripheral stage 222, the surface of the board 1 and the surface of the outer-peripheral stage 221 are present on the same plane.

As shown in FIG. 6B, the dry-film resist 300 transferred to the board 1 is formed by being laminated on the base film 400 by spin coating or the like. The formed dry-film resist 300 is held together with the base film 400 by the frame 500. And as shown in FIG. 6B, the frame 500 is held in a state inclined with respect to the stage 220 by the frame-holding mechanism 510 provided on the outer-peripheral stage 221. As a result, contact of the dry-film resist 300 with the board 1 before the transfer by the roller unit 204 can be prevented. And, to the dry-film resist 300, the roller unit 204, which is a transfer member, is pressed from a side opposite to the side opposed to the board 1 so as to apply a pressing force. And by relatively moving the roller unit 204 with respect to the resist 300 from the roller start position to the roller end position so as to widen an area to which the pressing force of the dry-film resist 300 is applied in a movement direction, the dry-film resist 300 is transferred to the board 1.

In this Embodiment, in order that a gap is not generated between the board 1 and the dry-film resist 300, a method of transfer sequentially from one direction as represented by a roller pressurizing method or the like is used. Note that, though not shown, in order that a gap is not generated between the board 1 and the dry-film resist 300, the transfer may be started after a pressure in the chamber is reduced. Here, a heating temperature of the roller unit 204 and a pressure by the roller unit 204 at the transfer can be set as appropriate as long as the dry-film resist 300 is softened and can cover the step on the surface of the board 1, and the nature of the resin is not changed. The heating temperature of the roller unit 204 and the pressure by the roller unit 204 can be set to at least 60° C. and not more than 140° C., at least 0.1 MPa and not more than 1.5 MPa, for example.

Here, returning to FIG. 3C, the explanation will be continued. As shown in FIG. 3C, by selectively exposing a part to be left in the flow-passage forming member 21 through a photomask and by performing thermal processing after the exposure (hereinafter, PEB), a hardened part 21A and an unhardened part 21B are optically determined. In this Embodiment, as the resin of the flow-passage forming member 21, use of the negative photosensitive resin is assumed and thus, the exposed part becomes the hardened part, and the hardened part 21A corresponds to a flow-passage wall, while the unhardened part 21B corresponds to a liquid flow-passage.

Subsequently, as shown in FIG. 3D, as a second step, the discharge-port forming member 31 fixed to the base film (not shown) is transferred onto the flow-passage forming member 21. The discharge-port forming member 31 uses the dry-film resist, and a material of a support member is not particularly limited as long as it is stable with respect to the heat history of the discharge-port forming member such as polyethylene terephthalate, polyimide or the like. Moreover, the material of the discharge-port forming member 31 is preferably a negative photosensitive resin similarly to the flow-passage forming member 21. Moreover, the temperature and the pressure of the roller unit 204 at the transfer can be set as appropriate as long as the discharge-port forming member 31 can be transferred, and the flow-passage forming member 21 having been already formed on the board 1 is not deformed. The heating temperature of the roller unit 204 and the pressure by the roller unit 204 can be set to at least 30° C. and not more than 50° C., at least 0.1 MPa and not more than 0.5 MPa, for example. After that, the base film is released from the discharge-port forming member 31, and only the discharge-port forming member 31 is left on the flow-passage forming member 21.

Subsequently, as shown in FIG. 3E, by selectively exposing a part to be left in the discharge-port forming member 31 through the photomask and by performing the PEB after the exposure, the hardened part 31A and the unhardened part 31B are optically determined. In this Embodiment, the negative photosensitive resin is assumed to be used as the resin of the discharge-port forming member 31 and thus, the exposed part becomes the hardened part, and the hardened part 31A corresponds to the nozzle forming the discharge port and a flow-passage ceiling, while the unhardened part 31B corresponds to the liquid discharge port 30.

Here, for the discharge-port forming member 31, it is preferable to use a material with higher sensitivity to the light at the exposure than that of the flow-passage forming member 21. As a result, acid is generated in the discharge-port forming member 31 by the exposure, but the acid is not generated in the unhardened part 21B of the flow-passage forming member 21. As a result, only the discharge-port forming member 31 can be selectively patterned. Note that, it may be so configured that a liquid-repellant film is formed on an upper surface of the discharge-port forming member 31 and then, the exposure is performed. Moreover, at the formation of the liquid-repellant film, the unhardened part of the flow-passage forming member 21 does not generate a hardening reaction.

Subsequently, as shown in FIG. 3F, a solvent is used for the unhardened parts of the flow-passage forming member 21 and the discharge-port forming member 31 for removal and dissolving and then, development is performed. Here, the development of the flow-passage forming member 21 and the discharge-port forming member 31 is preferably performed in a lump. Note that, performance of development in a lump refers to development of all the layers in one session of processing by using one type of the solvent.

Through the aforementioned processes, the board having the liquid discharge head in which such a nozzle portion is formed for causing a liquid having flown-in through the liquid supply port 11 to be discharged from the liquid discharge port 30 is completed. Then, by cutting/separating this board by a dicing saw or the like into chips, and after bonding of electric wirings for driving the energy generating elements or the like to each of the chips is performed, chip tank members for liquid supply are bonded. As a result, the liquid discharge head is completed.

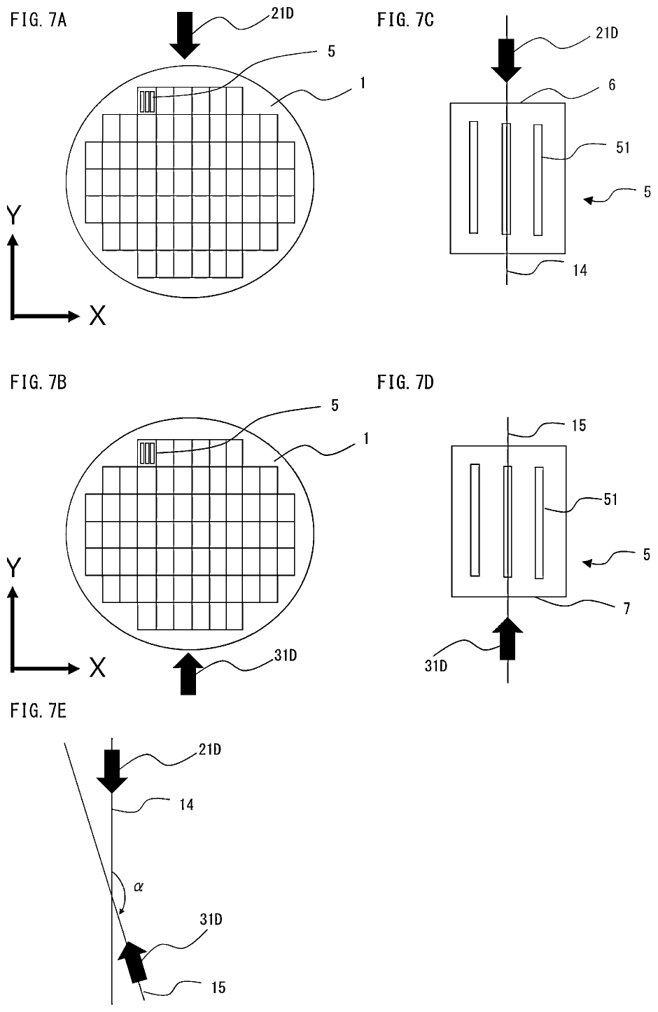

In this Embodiment, as shown in FIG. 7A and FIG. 7B, a transfer direction 21D (a direction of an arrow 21D in the drawing) of the flow-passage forming member 21 and a transfer direction 31D (a direction of an arrow 31D in the drawing) of the discharge-port forming member 31 are different from each other. Therefore, when the dry-film resist of the flow-passage forming member 21, which is a first resist, is to be transferred to the board 1, the roller unit 204 is moved so that the area in which the pressing force is applied to the resist is widened to the first direction (transfer direction 21D). Moreover, when the dry-film resist of the discharge-port forming member 31 of a second resist is to be transferred onto the dry-film resist of the flow-passage forming member 21, the roller unit 204 is moved so that the area in which the pressing force is applied to the resist is widened to the second direction (transfer direction 31D).

In this Embodiment, as shown in FIG. 7A and FIG. 7B, the board 1 has a plurality of sections 5 made of rectangles corresponding to the plurality of chips manufactured from the board 1 on the surface to which the resist is to be transferred. Moreover, a nozzle row 51 of the liquid discharge head in one chip is disposed in the rectangular section 5. FIG. 7C is an enlarged diagram of the one section 5 in FIG. 7A. Moreover, FIG. 7D is an enlarged diagram of the one section 5 in FIG. 7B. As can be seen from FIG. 7C and FIG. 7D, the first direction (transfer direction 21D) and the second direction (transfer direction 31D) are directions sandwiching sides 6, 7 opposed to each other of the rectangles constituting the section 5. As a result, variation in the thickness of the dry film by the transfer caused by characteristics of each transfer device is averaged, the thickness from the surface of the board 1 to the discharge-port forming member 31 is easily formed uniformly on the board 1, and the opening dimension of the liquid discharge port 30 can be easily formed uniformly.

Note that, in the example in the drawings, on a plan view of the board 1, an angle formed by a straight line 14 extending in the transfer direction 21D of the flow-passage forming member 21 and a straight line 15 extending in the transfer direction 31D of the discharge-port forming member 31 is 180°. That is, the first direction (transfer direction 21D) and the second direction (transfer direction 31D) in which the resist is transferred are directions along the sides of the rectangle of the section 5, respectively. However, the angle formed by the straight lines extending in these transfer directions is not limited to 180°. As shown in FIG. 7E, assume that an angle formed by the straight line 15 extending in the transfer direction 31D with respect to the straight line 14 extending in the transfer direction 21D is a. At this time, if variation in the thickness of the dry film caused by pressure distribution or temperature distribution in the transfer by the transfer device is small, these transfer directions are substantially opposed to each other, that is, the angle α formed by each of the directions only needs to be within a range from −5° to 5° (that is, at least 175° and not more than 185°). Moreover, in the dry-film resist of the discharge-port forming member 31, the liquid discharge ports are formed in plural so that at least one row is formed correspondingly to the nozzle row 51. At this time, as shown in the drawings, it is more preferable that a direction of the nozzle row 51 in the section 5 is parallel to either one of the transfer directions from a viewpoint that the thickness of the dry film in the extending direction of the nozzle row 51 is made uniform.

Moreover, when the transfer direction 21D of the flow-passage forming member 21 and the transfer direction 31D of the discharge-port forming member 31 are to be changed, the direction of a wafer on which the board 1 is placed can be changed by rotating the inner-peripheral stage 222. As a result, the thickness of the nozzle row 51 can be made uniform with accuracy without damaging inner-surface stability of the transfer device.

Note that, in the aforementioned explanation, the movement direction of the roller unit 204 at the transfer of the dry-film resist of the flow-passage forming member 21 and the movement direction of the roller unit 204 at the transfer of the dry-film resist of the discharge-port forming member 31 are changed. However, when at least either one of the dry-film resist of the flow-passage forming member 21 and the dry-film resist of the discharge-port forming member 31 is to be transferred, the heating and the pressurization may be repeated by changing the movement direction of the roller unit 204. That is, at the first step, the roller unit 204 is moved to the transfer direction 21D and then, the roller unit 204 is moved to a third direction, which is different from the transfer direction 21D. Here, as the third direction, the transfer direction 31D can be cited as an example. Alternatively, at the second step, after the roller unit 204 is moved to the transfer direction 31D, the roller unit 204 is moved to a fourth direction, which is different from the transfer direction 31D. Here, as the fourth direction, the transfer direction 21D can be cited as an example. As described above, in the transfer of one sheet of the dry-film resist, the effect that the thickness of the dry film is made uniform can be expected also by changing the movement direction of the roller unit 204.

Moreover, in the aforementioned explanation, the dry-film resist is assumed to be a sheet-type dry-film resist, but the aforementioned art can be also applied to the case of the transfer of a roll-form dry-film resist. In this case, the performance is made after a holding mechanism for the dry-film resist at the stage 220 is changed.

### Example 1

Subsequently, Example 1 of the aforementioned Embodiment will be explained with reference to the drawings. In this Example, the transfer direction 21D of the flow-passage forming member 21 and the transfer direction 31D of the discharge-port forming member 31 are configured such that they become parallel to the extending direction of the nozzle row 51, respectively, and the angle α formed by the transfer directions is 180°. That is, the first direction (transfer direction 21D) and the second direction (transfer direction 31D) are directions sandwiching the sides of the rectangles constituting the section 5 opposed to each other. As a result, such an effect can be obtained that the variation in the thickness of the dry film caused by the pressure distribution and the temperature distribution in the transfer by the transfer device is made smaller.

The manufacturing method of the liquid discharge head according to this Example will be also explained by using FIG. 3A to FIG. 3F. As shown in FIG. 3A, a plurality of the energy generating elements (not shown) are disposed on the board 1, and the insulating protective film (not shown) is formed from above. A silicon board is used for the board 1, and TaSiN is used for a heat-generating resistance body. Moreover, the insulating protective film is formed by plasma CVD of SiO, SiN. After that, a mask resist is formed from above the insulating protective film, and the board 1 is machined by dry-etching after the patterning so as to form the liquid supply port 11.

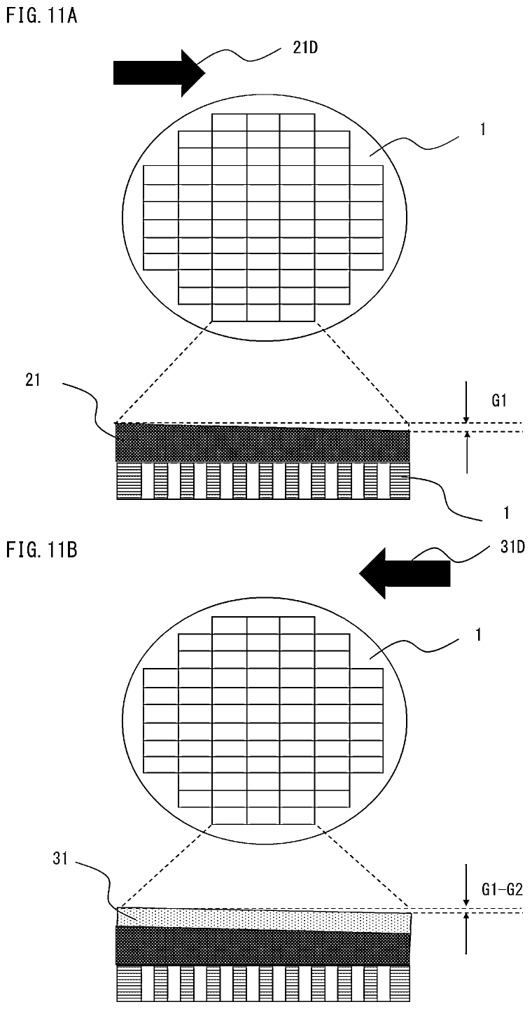

Subsequently, as shown in FIG. 3B, on the insulating protective film (not shown), the flow-passage forming member 21, which is a negative photosensitive resin, is formed as a dry film on the support member. The flow-passage forming member 21 is formed so that the thickness on the energy generating element becomes 14 μm. As the support member of the dry film, a release-processing PET film is used. Moreover, the transfer temperature by the roller unit 204 is set to 70° C., and the transfer pressure to 0.5 MPa. A release speed of the support member is 5 mm/s. Here, as shown in FIG. 7A, the transfer direction 21D of the flow-passage forming member 21 is a direction intersecting with one side 6 of the rectangular section 5 dividing a product unit of the liquid discharge head in the dry film on the board 1 and is a direction parallel to the nozzle row 51 disposed in one product unit. At this time, as shown in FIG. 11A, due to the variation in the thickness of the dry film caused by the pressure distribution and the temperature distribution specific to the transfer device, a thickness difference G1 is generated in the flow-passage forming member 21 as a whole.

Subsequently, as shown in FIG. 3C, a part to be a flow-passage side wall in the flow-passage forming member 21 is exposed by an i-line (wavelength; 365 nm) via a photomask and then, PEB is performed. An exposure amount is set to 8000 J/m². For PEB, heating at 50° C. is performed by a hot plate for 4 minutes so as to promote hardening reaction.

Subsequently, as shown in FIG. 3D, the discharge-port forming member 31 made of a dry-film state negative photosensitive resin is formed with a thickness of 10 μm on the flow-passage forming member 21. As the support member for the dry film, a PET film to which release processing was applied is used. Moreover, a transfer temperature by the roller unit 204 is set to 40° C., and a transfer pressure to 0.3 MPa. The release speed of the support member is set to 5 mm/s. Here, as shown in FIG. 7B, the transfer direction 31D of the discharge-port forming member 31 is a direction intersecting with one side 7 different from the one side 6 of the rectangular section 5 dividing the product unit of the liquid discharge head in the dry film on the board 1. Moreover, the transfer direction 31D is a direction parallel to the nozzle row 51 disposed in the one product unit. Furthermore, the transfer direction 31D of the discharge-port forming member 31 is a direction different from the transfer direction 21D of the flow-passage forming member 21 by 180°.

At this time, as shown in FIG. 11B, the variation in the thickness of the dry film due to the pressure distribution and the temperature distribution specific to the transfer device is averaged, and in the product unit, a relatively small thickness difference “G1−G2” (G1>G2) is generated.

Subsequently, as shown in FIG. 3E, a part to be a flow-passage ceiling in the discharge-port forming member 31 is exposed by the i-line (wavelength; 365 nm), and the hardened part 31A to be the flow-passage ceiling and the unhardened part 31B to be the discharge port are optically determined. An exposure amount is set to 1000 J/m². Here, the unhardened part 21B of the flow-passage forming member 21 is also irradiated with light, but hardening reaction of the unhardened part 21B by the exposure of the discharge-port forming member 31 is not generated by material photo-sensitivity adjustment. Then, the PEB is performed after this exposure. The PEB is performed by heating by a hot plate at 90° C. for 5 minutes so as to promote the hardening reaction.

Subsequently, as shown in FIG. 3F, the unhardened parts of the flow-passage forming member 21 and the discharge-port forming member 31 are removed in a lump by development processing, and the liquid flow-passage 20 and the liquid discharge port 30 are formed. Propylene glycol monomethyl acetate is used as a solvent of the unhardened part, and the development processing is performed for 15 minutes.

Through the aforementioned processes, the board for the liquid discharge head in which the nozzle portion is formed for causing the liquid having flown-in through the liquid supply port 11 to be discharged from the liquid discharge port 30 via the liquid flow-passage 20 is completed. By cutting and separating this board by a dicing saw or the like into chips, and after bonding of the electric wiring for driving the energy generating element to each of the chips, the chip tank member for liquid supply is bonded. As a result, the thickness from the surface of the board to the surface of the discharge-port forming member is formed uniformly in the product unit, and the liquid discharge head in which the opening dimension of the liquid discharge port is formed uniformly is completed. As the result of print with this liquid discharge head, it was confirmed that high-quality discharge characteristics were realized.

### Example 2

Subsequently, Example 2 of the aforementioned embodiment will be explained with reference to the drawings. In this Example, the transfer direction of the flow-passage forming member is set to a direction intersecting with one side of two sides connected to each other in the rectangular section dividing the product unit in the dry film on the board, and the transfer direction of the discharge-port forming member is set to a direction intersecting with the other side of the two sides. Since the other points of this Example are similar to those of Example 1, detailed explanation will be omitted.

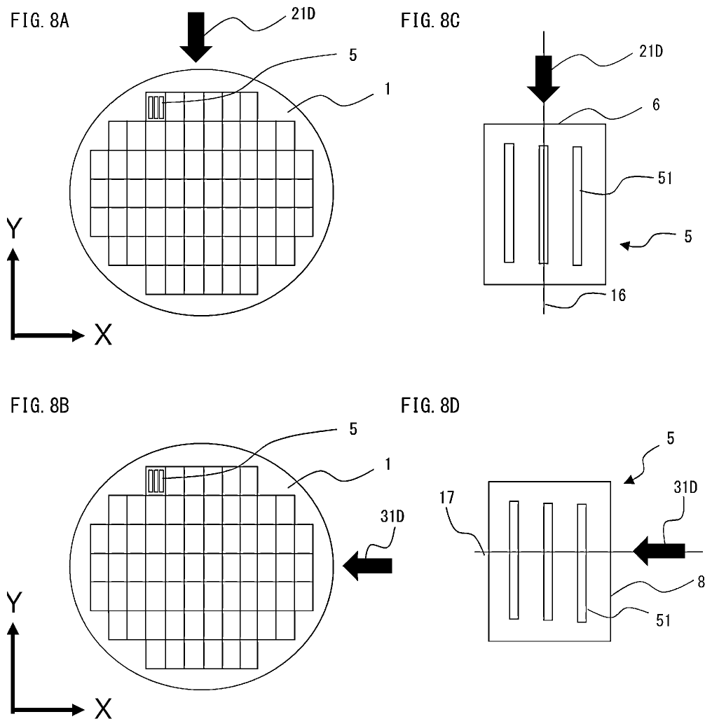

First, as shown in FIG. 8A and FIG. 8B, the transfer direction 21D (direction of an arrow 21D in the drawings) of the flow-passage forming member 21 and the transfer direction 31D (direction of an arrow 31D in the drawings) of the discharge-port forming member 31 are different from each other. As shown in FIG. 8A, the transfer direction 21D of the flow-passage forming member 21 is a direction parallel to the extending direction of the nozzle row 51 disposed in the section 5 of the product unit in the dry film on the board 1. Moreover, as shown in FIG. 8B, the transfer direction 31D of the discharge-port forming member 31 is a direction perpendicular to the extending direction of the nozzle row 51 in the dry film on the board 1.

Moreover, FIG. 8C is an enlarged diagram of the one section 5 in FIG. 8A. Moreover, FIG. 8D is an enlarged diagram of the one section 5 in FIG. 8B. As known from FIG. 8C and FIG. 8D, when a first straight line 16 extending in the first direction (transfer direction 21D) intersects with the rectangle of the section 5, the first straight line 16 intersects with the side 6 of the rectangle of the section 5. Moreover, when a second straight line 17 extending in the second direction (transfer direction 31D) intersects with the rectangle of the section 5, the second straight line 17 intersects with the side 8, which is different from the side 6 of the rectangle of the section 5. Note that, in the example in the drawings, the first direction and the second direction are directions orthogonal to each other, but an angle formed by the first direction and the second direction is not limited to that.

For example, on the board 1, when the liquid discharge port 30 of the liquid discharge head is to be disposed in the rectangular section 5, the aforementioned transfer direction may be a direction intersecting with a side of the rectangle constituting the section 5, which are different from each other. At this time, if the angle α formed by each of the transfer directions is at least 45°, such an effect can be expected that the variation in the thickness of the dry film at the transfer becomes smaller. That is, the angle α (FIG. 7E) formed by the straight line extending in the first direction (transfer direction 21D) and the straight line extending in the second direction (transfer direction 31D) is at least 45° and not more than 315°.

According to this Example, such an advantage can be obtained that, similarly to Example 1, the variation in the thickness of the dry film caused by the pressure distribution and the temperature distribution specific to the transfer device is averaged. Moreover, similarly to Example 1, the liquid discharge head in which the thickness from the surface of the board to the surface of the discharge-port forming member is formed uniformly in the product unit, and the opening dimension of the liquid discharge port is also formed uniformly is completed. As the result of print performed with this liquid discharge head, it was confirmed that high-quality discharge characteristics were realized.

### Comparative Example

Here, as a comparative example of the aforementioned Examples 1, 2, an example of the manufacturing method of the liquid discharge head of the conventional art will be explained. In this Comparative Example, the transfer direction of the flow-passage forming member and the transfer direction of the discharge-port forming member are the direction intersecting with the same side of the rectangle dividing the product unit in the dry film on the board. The other points of this Comparative Example are similar to those of Example 1.

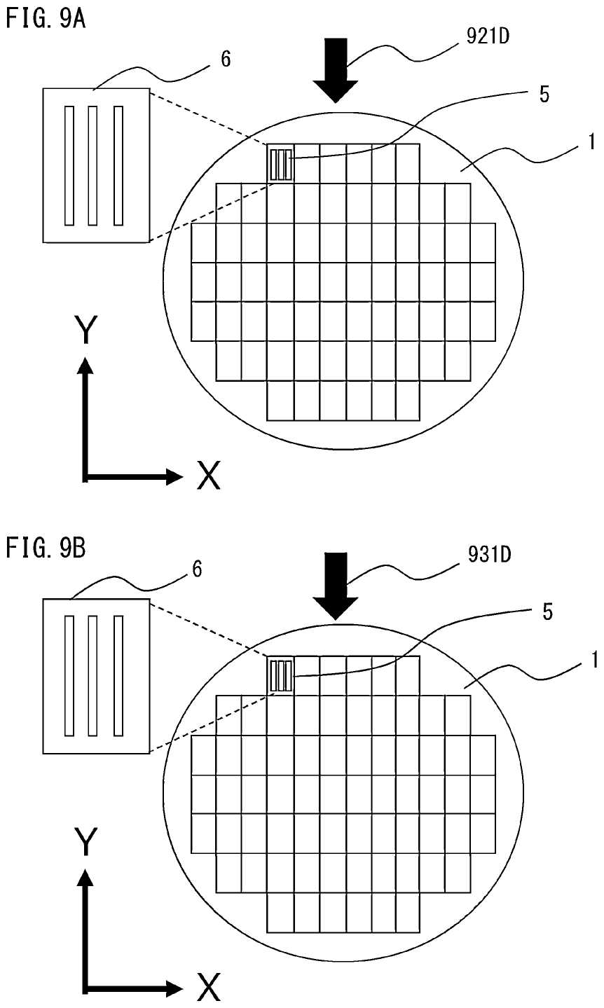

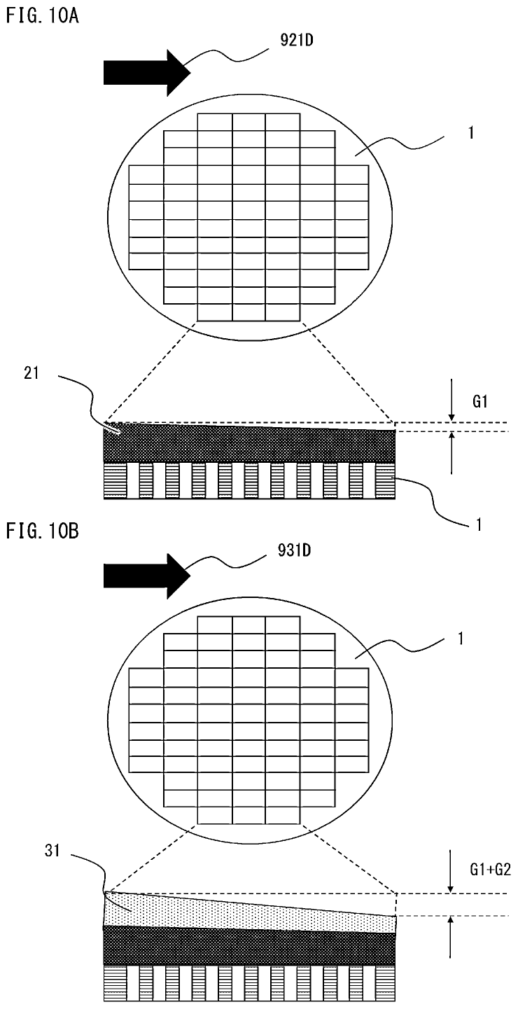

As shown in FIG. 9A, a transfer direction 921D of the flow-passage forming member in this Comparative Example is a direction parallel to the extending direction of the nozzle row 51 disposed in the product unit in the dry film on the board 1 and is a direction intersecting with the side 6 of the rectangle dividing the product unit. At this time, as shown in FIG. 10A, with the variation in the thickness of the dry film caused by the pressure distribution or the temperature distribution specific to the transfer device, a thickness difference of G1 is generated in the flow-passage forming member.

Subsequently, as shown in FIG. 9B, a transfer direction 931D of the discharge-port forming member is the same direction as the transfer direction 921D of the flow-passage forming member. As a result, as shown in FIG. 10B, the variation in the thickness of the dry film caused by the pressure distribution or the temperature distribution specific to the transfer device is added to the thickness difference generated at the formation of the flow-passage forming member. As a result, a thickness difference “G1+G2”, which is larger than the thickness difference in each of the aforementioned Examples, is generated in the product unit.

And by the processes similar to those in Examples 1, 2, the liquid discharge head having the flow passage and the discharge port is completed. As the result of print performed with this liquid discharge head, print with a slightly unstable liquid discharge amount was generated, and it was known that, with the liquid discharge head, the discharge-port opening dimension or the variation in the nozzle thickness from the board surface becomes larger in the product unit as compared with Examples 1, 2.

According to the art of this disclosure, the variation in the thickness of the dry film used for the liquid discharge head is suppressed, and the liquid discharge head with higher quality can be manufactured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-114065, filed on Jul. 11, 2023, which is hereby incorporated by reference herein in its entirety.

What is claimed is:

1. A manufacturing method of a liquid discharge head for manufacturing a liquid discharge head by transferring a resist to a board having a liquid supply port of the liquid discharge head, comprising:
in order to transfer a first resist to the board, a first step of transferring the first resist to the board by relatively moving a transfer member to a first direction in a state where the transfer member is pressed from a side opposite to a side opposed to the board with respect to the first resist; and
in order to transfer a second resist onto the first resist having been transferred to the board, a second step of transferring the second resist onto the first resist by relatively moving the transfer member to a second direction, which is different from the first direction, in a state where the transfer member is pressed from a side opposite to a side opposed to the first resist with respect to the second resist.

2. The manufacturing method of a liquid discharge head according to claim 1, wherein
the board has, on a surface to which the resist is transferred, a section formed of a plurality of rectangles corresponding to a plurality of chips to be manufactured from the board; and
the first direction and the second direction are directions along sides of the rectangle, respectively.

3. The manufacturing method of a liquid discharge head according to claim 1, wherein
the first direction and the second direction are directions opposed to each other.

4. The manufacturing method of a liquid discharge head according to claim 3, wherein
an angle formed by the first direction and the second direction is within a range from −5° to 5°.

5. The manufacturing method of a liquid discharge head according to claim 1, wherein
the first direction and the second direction are directions orthogonal to each other.

6. The manufacturing method of a liquid discharge head according to claim 1, wherein
an angle formed by the first direction and the second direction is at least 45° and not more than 315°.

7. The manufacturing method of a liquid discharge head according to claim 1, wherein
the first resist is a resist for forming a flow passage for the liquid supply port; and
the second resist is a resist for forming a liquid discharge port for the liquid supply port.

8. The manufacturing method of a liquid discharge head according to claim 7, wherein
in the second resist, the liquid discharge ports are formed in plural and form at least one row; and
the first direction and the second direction are directions parallel to the at least one row.

9. The manufacturing method of a liquid discharge head according to claim 1, wherein
in the first step and the second step, the transfer member is heated.

10. The manufacturing method of a liquid discharge head according to claim 1 wherein
in the first step, after the transfer member is moved to the first direction, the transfer member is moved to a third direction, which is different from the first direction.

11. The manufacturing method of a liquid discharge head according to claim 1, wherein
in the second step, after the transfer member is moved to the second direction, the transfer member is moved to a fourth direction, which is different from the second direction.
